(19) United States
(12) Patent Application Publication
(10) Pub. No.: US 2023/0182151 A1
(43) Pub. Date: Jun. 15, 2023

(54) Centrifuge

(71) Applicant: Andreas Hettich GmbH & Co. KG, Tuttlingen (DE)

(72) Inventors: BERND FIEDLER, Bad Blankenburg (DE); ANDREAS HOELDERLE, Braeunlingen-Doeggingen (DE); MATTHIAS HORNEK, Tuttlingen (DE); KLAUS-GUENTER EBERLE, Tuttlingen (DE)

(73) Assignee: Andreas Hettich GmbH & Co. KG, Tuttlingen (DE)

(21) Appl. No.: 17/925,006

(22) PCT Filed: May 20, 2021
(86) PCT No.: PCT/EP2021/063510

§ 371 Date: Nov. 13, 2022

(30) Foreign Application Priority Data
May 20, 2020 (DE) 10 2020 113 765.6

(51) Int. Cl. B04B 9/12; B04B 5/04; F16F 15/06; F16F 15/08

(52) U.S. Cl. CPC B04B 9/12; B04B 5/0407; F16F 15/06; F16F 15/085; F16F 2234/02; F16F 2230/0052; F16F 2224/0208; F16F 2228/007

(57) ABSTRACT

The invention relates to a centrifuge (10), in particular a laboratory centrifuge, having a) a rotor (32) for receiving containers having material for centrifuging, b) a drive shaft (42), on which the rotor (32) is mounted, c) a motor (18), which drives the rotor (32) via the drive shaft (42), d) a bearing unit (44) having bearings (20, 22, 24; 46, 48, 50, 52, 54, 56; 64, 66, 68), which each have damping elements (20a, 22a, 24a; 46a, 48a, 50a; 52a, 54a, 56a, 64a, 66a, 68a) comprising a spring axis (20e, 22e, 24e; 46e, 48e, 50e; 52e, 54e, 56e; 64e, 66e, 68e), and e) a carrier element (16) for fixing the motor (18) via the bearing unit (44) in the centrifuge (10). The invention is characterized in that at least one damping element is formed completely from metal and as a metal cushion (46a, 48a, 50a; 52a, 54a, 56a, 64a, 66a, 68a) comprising a wire knit having elastic properties.

This patent application is the national phase entry into the United States of America of PCT/EP2021/063510, international application filing date May 20, 2021, which claims the benefit of and priority of and to German patent application No. 10 2020 113 765.6, filed May 20, 2020.

PCT/EP2021/063510, international application filing date May 20, 2021 and German patent application No. 10 2020 113 765.6, filed May 20, 2020, are incorporated herein by reference hereto in their entireties.

The invention relates to a centrifuge, in particular a laboratory centrifuge.

Centrifuges of many different designs are known per se. Especially for laboratory centrifuges, efforts have always been made to propose devices that are as compact as possible, since laboratory space is often limited. In addition, laboratory centrifuges are usually loaded and unloaded from above, so there must be sufficient clearance above these centrifuges for opening the lid.

At the same time, good damping must be taken into account when designing a centrifuge so as to counteract the imbalances that will inevitably occur in the centrifuge during operation. For this purpose, it is generally known, for example, to support the motor carrying the rotor on damping elements whose spring axes are parallel to the longitudinal axis of the motor. Usually, the damping elements are essentially made of natural/synthetic rubber. Such damping elements made of natural/synthetic rubber are reasonably priced and are available as a catalog part in a wide variety of designs and materials. Their properties are clearly defined and documented, which means that damping elements of such designs can be used in a wide range of applications. For this reason, these damping elements are used for any new design or redesign of a centrifuge. This type of damping elements is also completely sufficient for applications in which no major imbalances occur during operation.

Centrifuges of this design are also used in fully automated systems. The use of dual rotors for example requires the centrifuge to have a high imbalance tolerance. This is the case, for example, when the rotor has been loaded with an odd number of samples, resulting in a centrifuge run with, for example, with fully loaded buckets of a rotor on the one side and unloaded buckets of a rotor on the other side.

However, centrifuges are used for more and more complex tasks. The imbalance occurring during centrifuge operation is increasingly becoming a problem for such complex tasks and processes, since the known rubber damping elements are proving to be inadequate in terms of their damping properties and their damping range. Damping elements of a previous design will only absorb the forces generated to an insufficient extent—which has a detrimental effect on the processes to be performed. On the other hand, these damping elements are also stressed in a way that will shorten their service life and that of the centrifuge.

Attempts have therefore been made to solve this problem using different alignments of the spring axes of the damping elements with respect to the rotor and the motor. In addition, several different types of damping elements were connected in series.

A centrifuge is known from DE 39 22 744 A1, for example, which has a rotor for receiving containers with material to be centrifuged. Its rotor is driven via a drive shaft, for which purpose the drive shaft is connected to a motor. The motor with the drive shaft and the rotor is in turn connected to a bearing unit that has several damping elements comprising a spring axis. The whole thing is connected to a support element for fixing the motor along with the components supported by the motor in place in the centrifuge. The spring axes of the damping elements can be set at an acute angle δ with respect to the axis of rotation Y of the motor. The damping elements are each connected to the bearing unit via a strut. The struts are set and arranged in such a way that they are concentrically aligned with the respective spring axis of each of the damping elements. The bearing unit includes a support plate. A damping element is formed by a coil spring and another damping element in the form of two equalizing chambers, between which damping fluid flows through a throttle channel depending on the direction of load.

It is known from WO 2015/128296 A1 to set the spring axes of the damping elements at an angle and to use metal leaf springs (referred to as lugs in this document) as a further damping element in combination with the rubber buffers.

GB 739 666 A discloses a centrifuge in which rubber cushions are provided as damping elements, and arms damped via frictional resistance are provided as further damping elements.

U.S. Pat. No. 1,848,641 A discloses a centrifuge in which the motor is supported in the housing by struts and damping elements in the form of springs.

DE 195 16 904 A1 discloses a laboratory centrifuge with a vibration damping device made of rubber.

The known measures for damping the motor with the rotor supported by the motor are not very effective, especially in the 15 to 50 Hz frequency range. However, the aim is to determine both the permissible imbalance of a centrifuge as well as the damping over the entire frequency range occurring during centrifuge operation in order to thereby increase the application options of a centrifuge and still ensure safe centrifuge operation. There must be no rotor breakout in this process, especially not in the critical resonance range. Rotor deflection is to be kept as small as possible. The overall size must not increase due to the additional measures for improved damping.

At the same time, vibration transmission from the rotating mass, i.e. the imbalanced rotor in operation which may only be partially loaded, to the support plate with the centrifuge housing connected to the support plate is to be kept as low as possible. Otherwise, unacceptable noise will occur. The vibrations will cause the centrifuge to start moving, for example, on the laboratory bench.

It is the object of the invention to further improve on a centrifuge in such a way that sufficient damping is achieved over an as large as possible frequency range whilst avoiding the above mentioned shortcomings.

The invention is based on the insight that metal cushions, which are known from heavy-duty applications and harsh environmental conditions, can be used as damping elements, since they have considerably better damping properties over a wide frequency range than damping elements previously known for use in centrifuges.

According to the invention, therefore, at least one damping element is formed entirely of metal as a metal cushion comprising a knitted wire mesh with elastic properties. However, the individual parameters of the metal cushions for centrifuges need first to be determined in a complex manner.

Diagrams with frequency-dependent values on damping in metal cushions are not available from the manufacturers of such metal cushions. Therefore, complex calculations and measurements are required to be able to design such metal cushions for relatively light-weight centrifuges, especially for laboratory centrifuges. All measurements, calculations and simulations for the design of metal cushions for centrifuges will therefore have to be carried out step by step for individual types of centrifuges. Once this has been done, and the parameters have been optimized for the centrifuge, the results are excellent in terms of damping characteristics over a wide frequency range.

For certain mounting situations, it is advantageous for the metal cushion to be of a cylindrical design. This allows a space-saving design of the metal cushion, taking into account the cross-sectional area of the already existing coupling elements and/or the required surface for the force absorption.

To accommodate different loads on the rotor, two metal cushions together form a damping element, with the first metal cushion counteracting a first direction of deflection, and the second cushion counteracting a second, in particular opposite, direction of deflection of the rotor. This ensures that the metal cushion is only subjected to compressive loads, as metal cushions can be damaged or even destroyed by tensile loads.

In an advantageous embodiment of the invention, the bearing unit comprises at least one bearing with a bearing plate. The first metal cushion is arranged on one side of the bearing plate, and the second metal cushion is arranged on the second side of the bearing plate.

A guide pin can pass through the first metal cushion that rests directly or indirectly against the bearing plate, the bearing plate and the second metal cushion that rests directly or indirectly against the bearing plate and the support element. One side of the guide pin is firmly connected to the support element. On the other side of the guide pin, a head is provided to directly or indirectly abut the first metal cushion. The first metal cushion, the bearing plate and the second metal cushion are freely movable relative to the guide pin. This ensures damping in opposite directions with respect to each other, which is necessary to dampen possible movements in these directions during operation, yet subjecting each of the metal cushions to compressive loads only.

The damping elements of different bearings can also be designed differently. In particular, the damping elements of a first bearing are optimized with regard to damping, and the damping elements of a second bearing are optimized with regard to absorbing the weight force. For example, one damping element of the first bearing may comprise at least one metal cushion, and the other damping element of the second bearing may comprise at least natural/synthetic rubber.

This has the advantage that it essentially allows the bearings with the metal cushions to be optimally designed for the required damping of the centrifuge bearing unit, with the bearings with the natural/synthetic rubber absorbing the load of the motor with the rotor. This means that the lower and upper metal cushions, for example, will be subjected to equal loads. This allows the use of metal cushions that are optimized for damping. The load of the motor with the rotor need not be considered in the design of the metal cushions. Basically, this means that smaller, softer metal cushions can be used, since they will not have to bear the load of the motor and the rotor, and they will not be preloaded thereby either.

Preferably, the spacing of adjacent damping elements and/or bearings in the circumferential direction with respect to the drive shaft is the same.

For some applications, it may be advantageous for at least one spring axis of a damping element to be aligned perpendicular to the drive shaft.

In addition or as an alternative, at least one spring axis of a damping element can also be aligned parallel to the drive shaft.

In one embodiment of the invention, multiple bearings with damping elements are provided. The spring axes of half of the damping elements are aligned perpendicular to the drive shaft, and the spring axes of the other half of the damping elements are aligned parallel to the drive shaft.

In this case, the spring axes of the damping elements can be alternatingly aligned perpendicular to the drive shaft and parallel to the drive shaft.

Preferably, the damping elements allow a maximum deflection in the area of the rotor of less than 2 mm, in particular of less than 1.5 mm, and/or, in the area of the damping element, of less than 1 mm, in particular of less than 0.9 mm.

For example, three damping elements can be provided, each having its spring axis aligned in the same way.

In one embodiment of the invention, a washer, in particular a metal washer, is used to delimit the damping element in the direction of the spring axis on one side. The washer is used to ensure that the forces occurring are applied or transmitted over the entire cross-sectional area of the damping element.

The washer can completely cover the damping element in the direction of the spring axis.

In order to prevent corrosion from occurring, the metal cushion is formed by a steel wire that contains chromium-nickel. The steel wire is thus a stainless steel wire.

Preferably, the diameter of the steel wire is from 0.05 mm up to and including 0.5 mm. This range has shown to result in optimum elastic deformation for the intended application.

For example, the outer diameter of the metal cushion may be from 12 mm up to and including 50 mm.

In particular, the metal cushion can be designed as a hollow cylinder, especially with a diameter between 4 mm and 12 mm.

In order to meet the requirements of the centrifuge in operation as optimally as possible, the damping coefficient k of the metal cushion at a given excitation frequency is in the following ranges:
for an excitation frequency of 1 Hz, the damping coefficient k is between 500 and 8,000 Ns/m;
for an excitation frequency of 10 Hz, the damping coefficient k is between 300 and 5,000 Ns/m;
for an excitation frequency of 20 Hz, the damping coefficient k is between 200 and 2,500 Ns/m;
for an excitation frequency of 50 Hz, the damping coefficient k is between 80 and 1,200 Ns/m;
for an excitation frequency of 100 Hz, the damping coefficient k is between 40 and 500 Ns/m;

In one embodiment of the invention, the stiffness (c) of the metal cushion is in a range of between 3 and 300 N/mm.

The advantage of using metal cushions in centrifuges, in addition to the above-mentioned damping properties, is their resistance to aging. There is no hardening or creep of the material. The use of stainless steel makes them corrosion resistant to solvents, acids, oils, greases, liquids and dust. Moreover, such metal cushions have a high resistance to aging. Metal cushions have a high imbalance tolerance, require little installation space and can therefore be placed relatively close to the motor and rotor in the centrifuge housing. The pressure-loaded installation also increases operational reliability. Tearing is prevented by the metal cushions—in contrast to the previously known rubber elements, which cracked under tensile load. In addition, the parameters of the metal cushion remain approximately the same over its service life. There are also no changes in the parameters of the metal cushion when subjected to temperature fluctuations. It can thus be used in a heated engine compartment without any problem and without affecting the running behavior of the centrifuge.

Additional advantages, features and possible applications of the present invention will be apparent from the description which follows, in which reference is made to the embodiments illustrated in the drawings.

Throughout the description, the claims and the drawings, those terms and associated reference signs are used as are stated in the list of reference signs below. In the drawings,

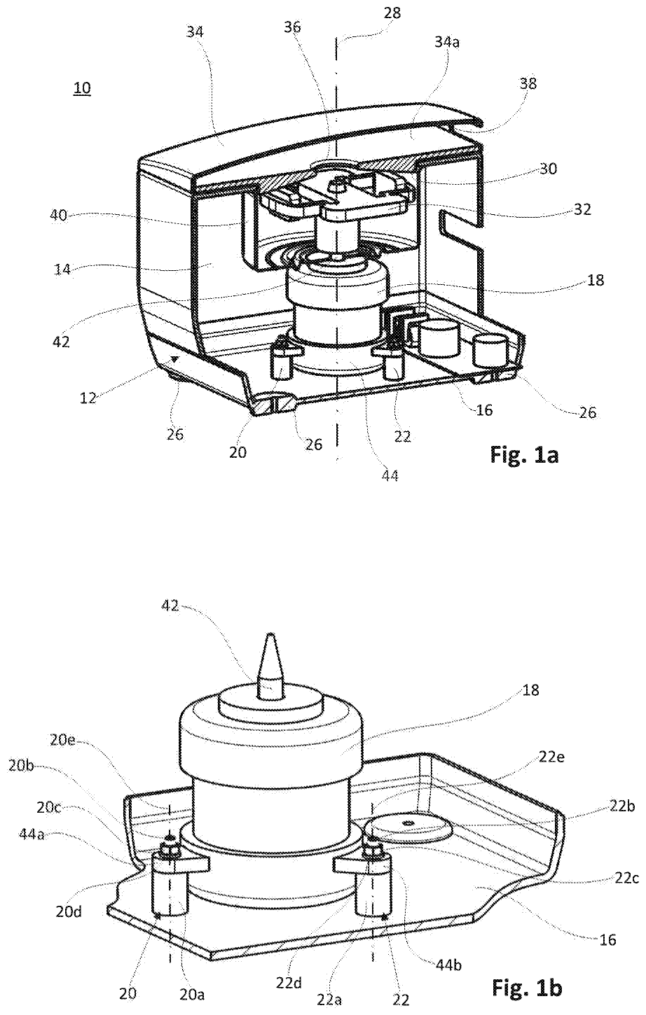

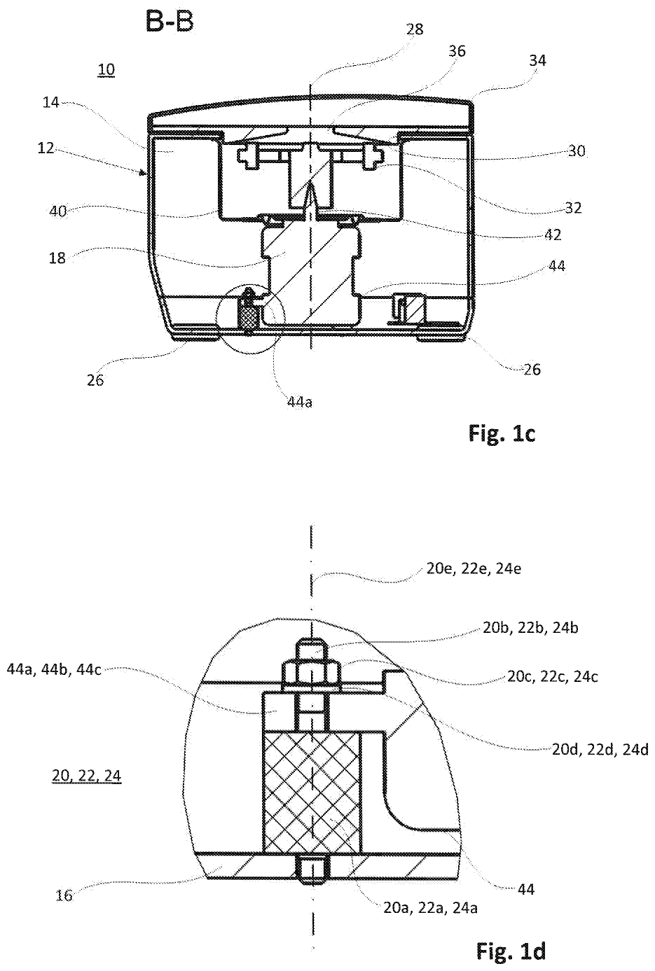

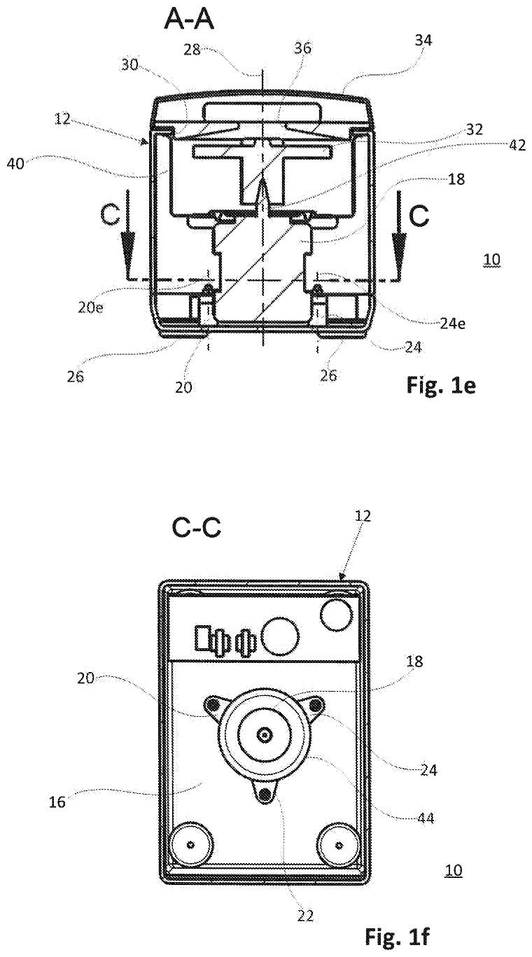

FIG. 1a is a cutaway perspective view of the centrifuge with motor, rotor, safety vessel and prior art damping elements made of rubber;

FIG. 1b is a perspective partial view of FIG. 1a showing the motor mounted in the centrifuge housing with bearing plates and damping elements;

FIG. 1c is a longitudinal sectional view of FIG. 1a;

FIG. 1d is a partial cross-sectional view Z of FIG. 1c;

FIG. 1e is a cross-sectional view of FIG. 1a;

FIG. 1f is a sectional view from above, taken along line C-C of FIG. 1e;

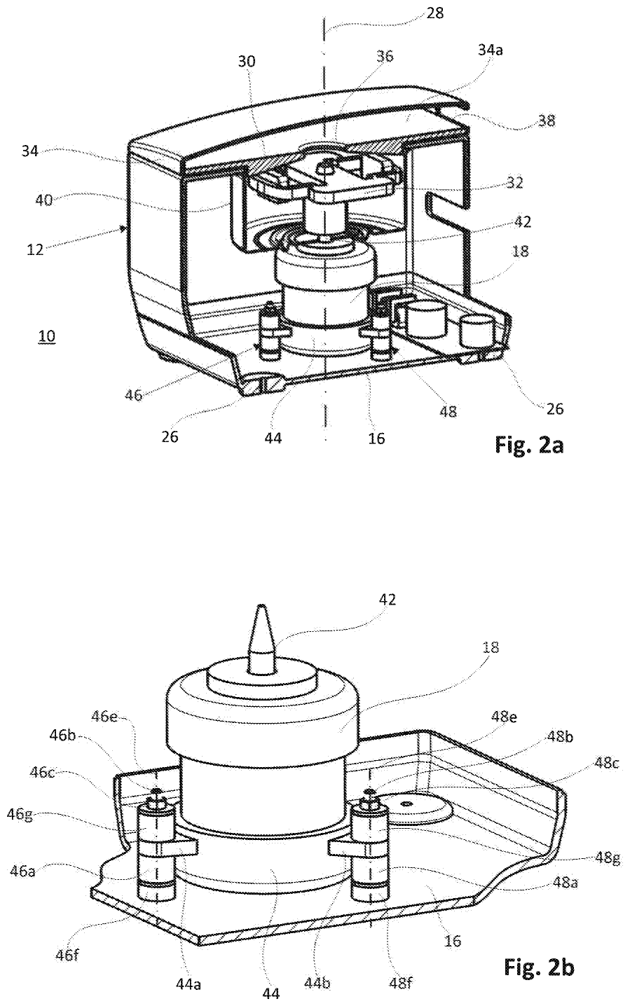

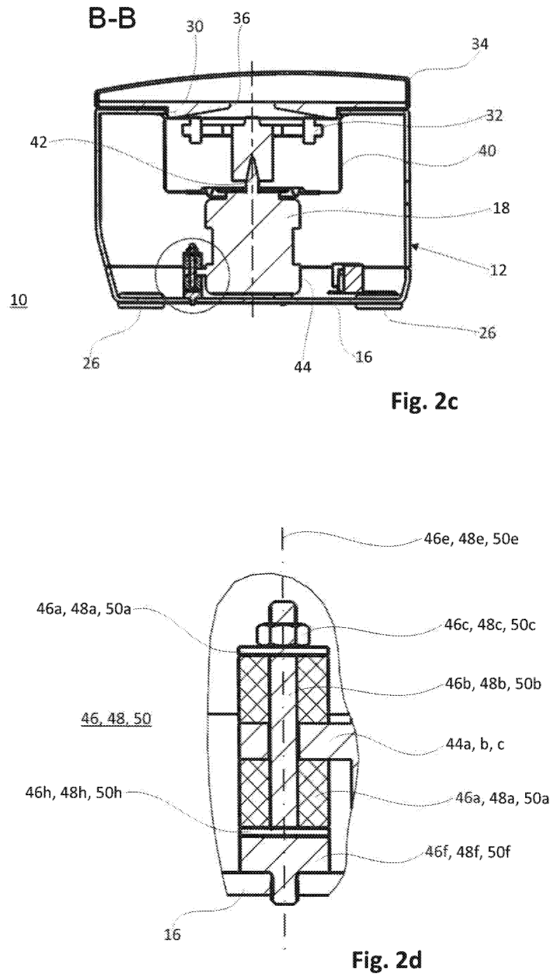

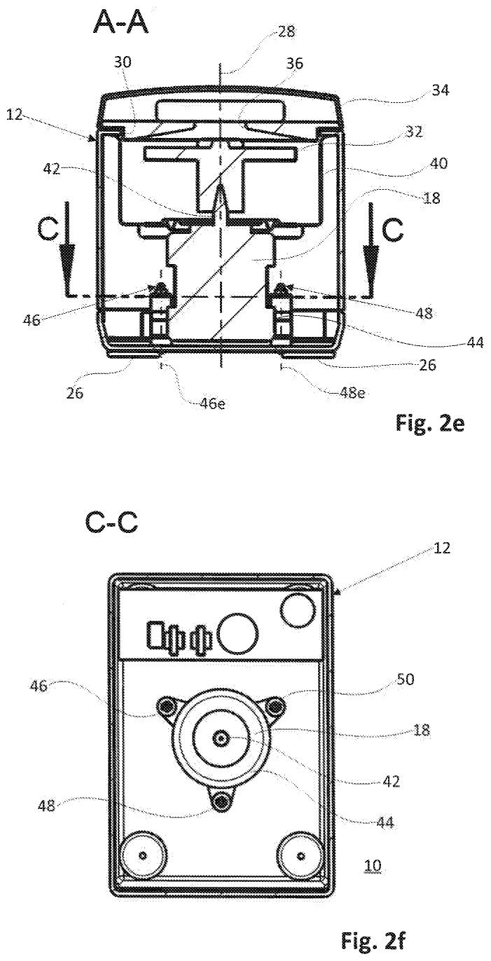

FIG. 2a is a cutaway perspective view of the centrifuge with motor, rotor, safety vessel and damping elements according to a first embodiment of the invention;

FIG. 2b is a perspective partial view of FIG. 2a of the motor mounted in the centrifuge housing with bearing plates and damping elements according to a first embodiment of the invention;

FIG. 2c is a longitudinal sectional view of FIG. 2a;

FIG. 2d is a partial cross-sectional view Z of FIG. 2c;

FIG. 2e is a cross-sectional view of FIG. 2a;

FIG. 2f is a sectional view from above, taken along line C-C of FIG. 2e;

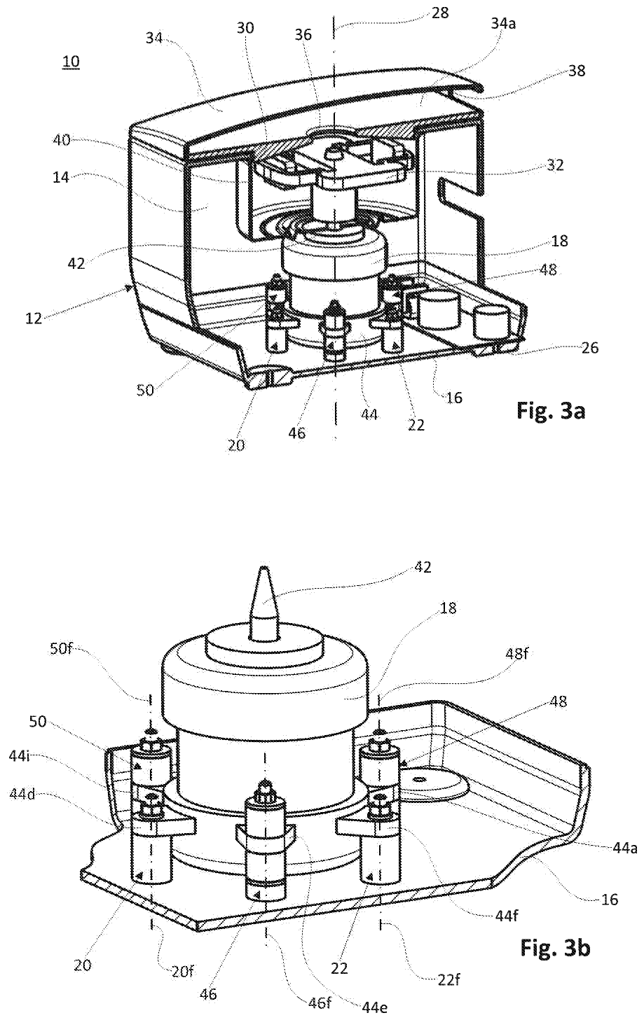

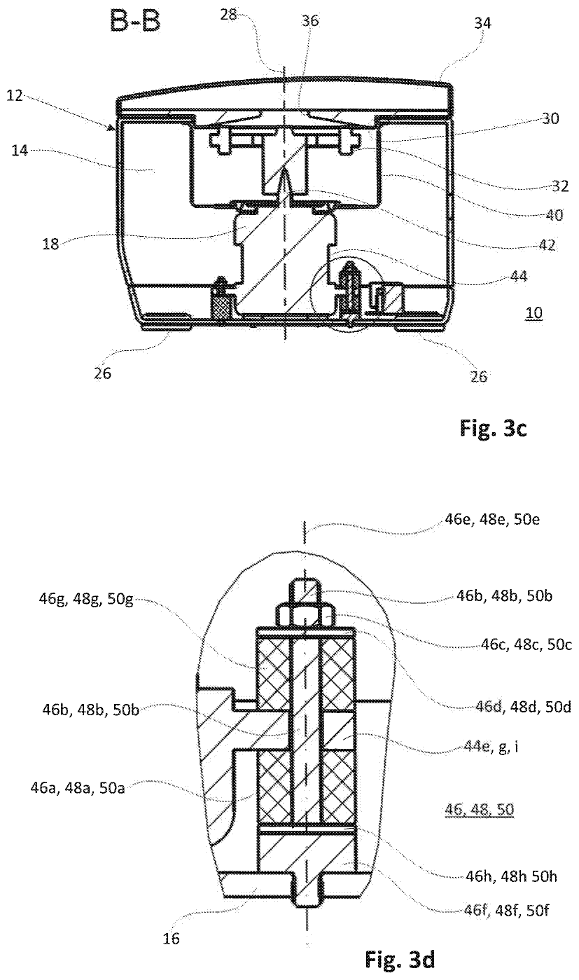

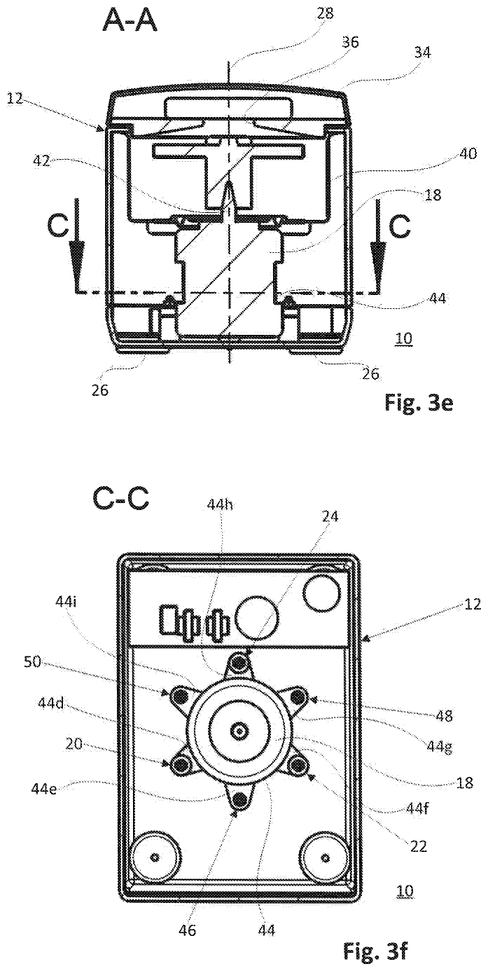

FIG. 3a is a cutaway perspective view of the centrifuge according to a second embodiment of the invention with the motor, rotor, safety vessel and damping elements of FIG. 2 in combination with the prior art damping elements of FIG. 1;

FIG. 3b is a perspective partial view of FIG. 3a of the motor mounted in the centrifuge housing with bearing plates and damping elements;

FIG. 3c is a longitudinal sectional view of FIG. 3a;

FIG. 3d is a partial cross-sectional view Z of FIG. 3c;

FIG. 3e is a cross-sectional view of FIG. 3a;

FIG. 3f is a sectional view from above, taken along line C-C of FIG. 3e;

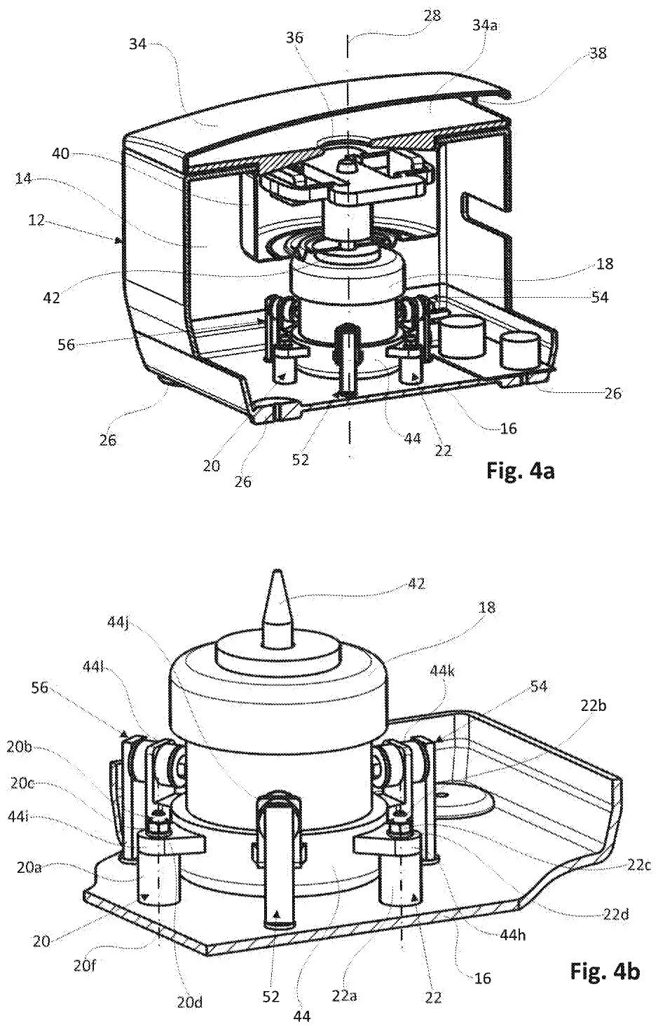

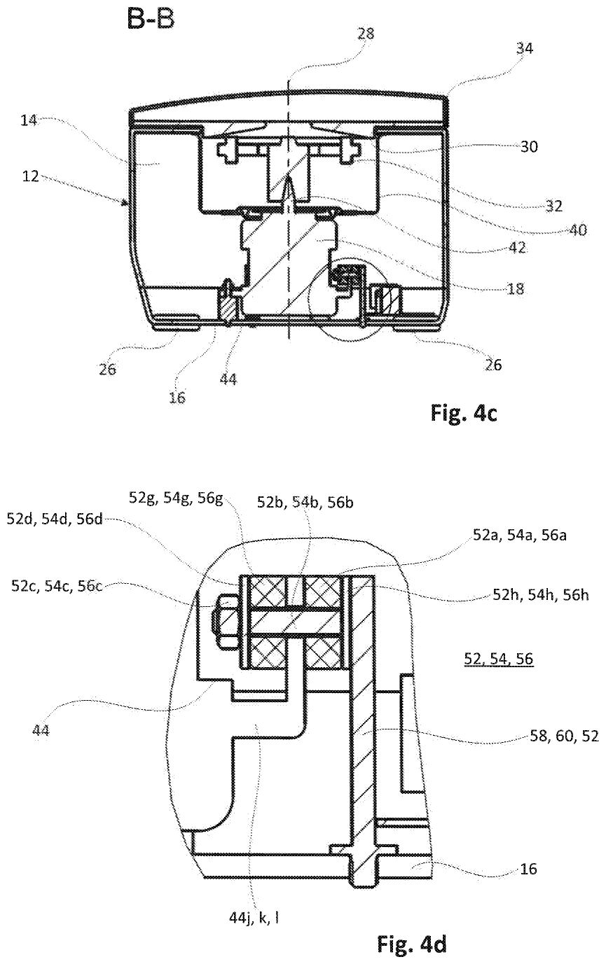

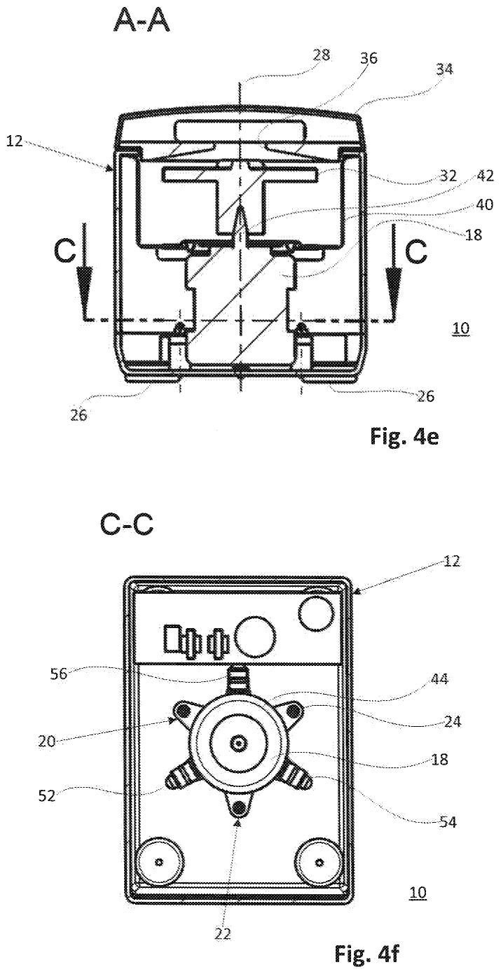

FIG. 4a is a cutaway perspective view of the centrifuge according to a third embodiment of the invention with the motor, rotor, safety vessel and prior art damping elements of FIG. 1 and a further embodiment;

FIG. 4b is a perspective partial view of FIG. 4a of the motor mounted in the centrifuge housing with bearing plates and damping elements;

FIG. 4c is a longitudinal sectional view of FIG. 4a;

FIG. 4d is a partial cross-sectional view Z of FIG. 4c;

FIG. 4e is a cross-sectional view of FIG. 4a;

FIG. 4f is a sectional view from above, taken along line C-C of FIG. 4e;

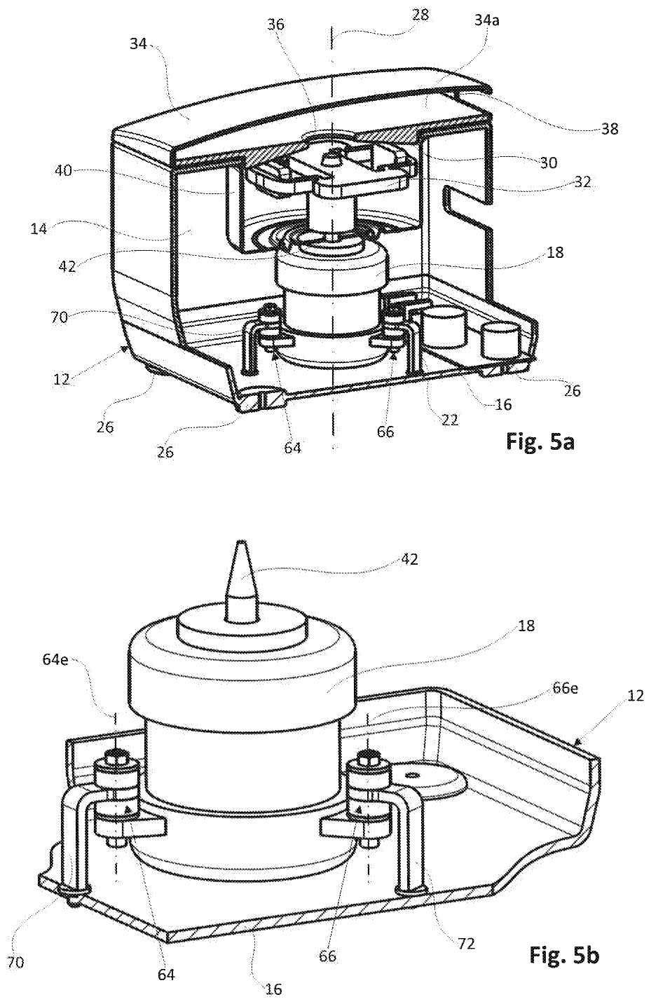

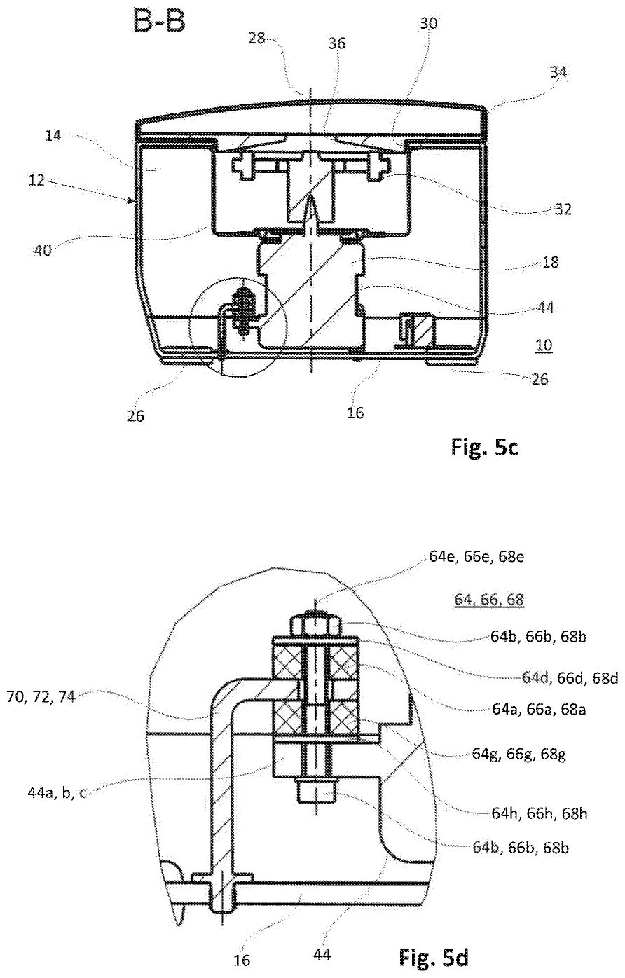

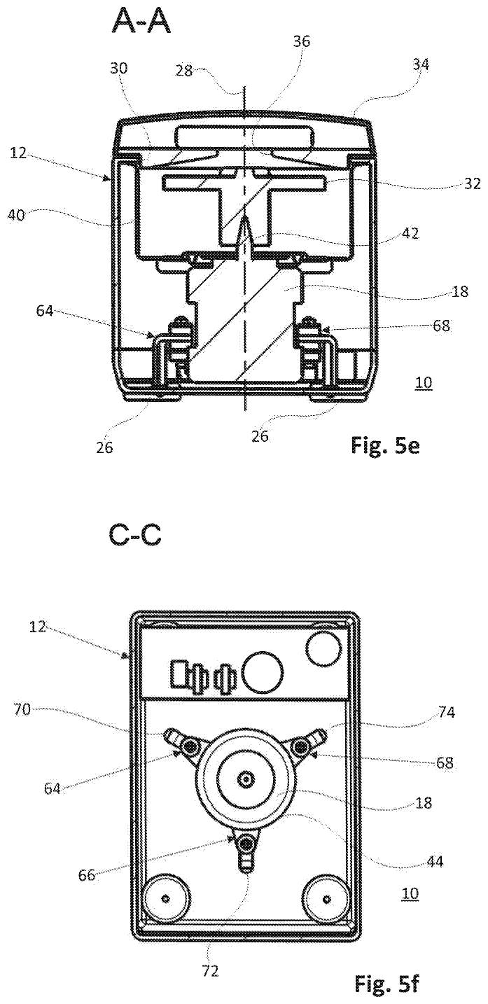

FIG. 5a is a cutaway perspective view of the centrifuge according to a fourth embodiment of the invention with the motor, rotor, safety vessel and damping elements according to a further embodiment;

FIG. 5b is a perspective partial view of FIG. 5a of the motor mounted in the centrifuge housing with bearing plates and damping elements;

FIG. 5c is a longitudinal sectional view of FIG. 5a;

FIG. 5d is a partial cross-sectional view Z of FIG. 5c;

FIG. 5e is a cross-sectional view of FIG. 5a;

FIG. 5f is a sectional view from above, taken along line C-C of FIG. 5e;

FIG. 6 shows diagrams illustrating the deflection of the motor shaft at the top (in the area of the rotor) and at the bottom (in the area of the bearing, i.e. the damping elements); and

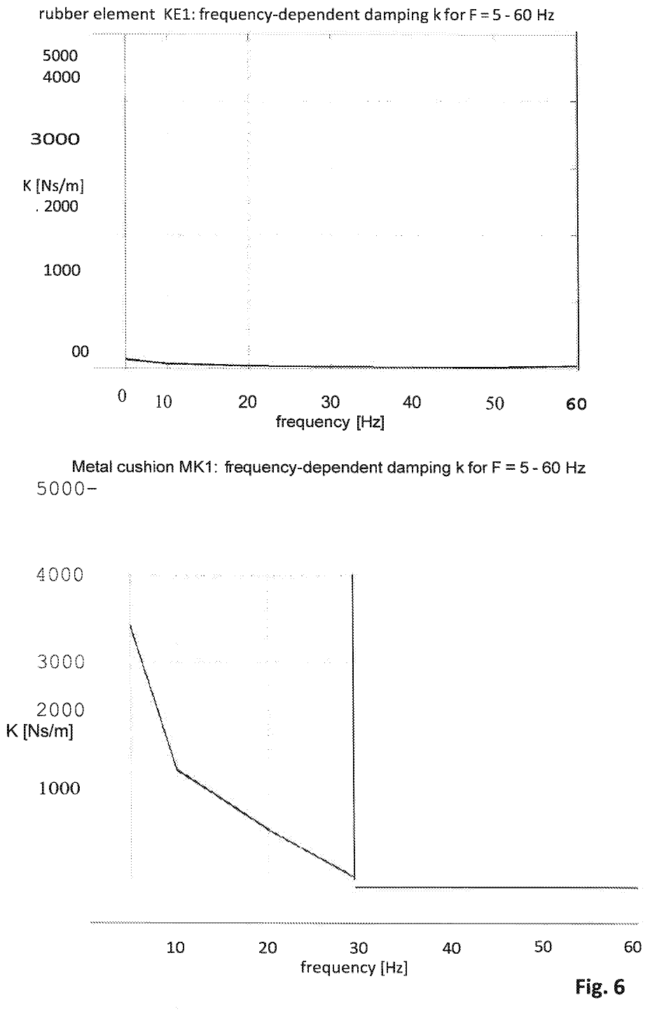

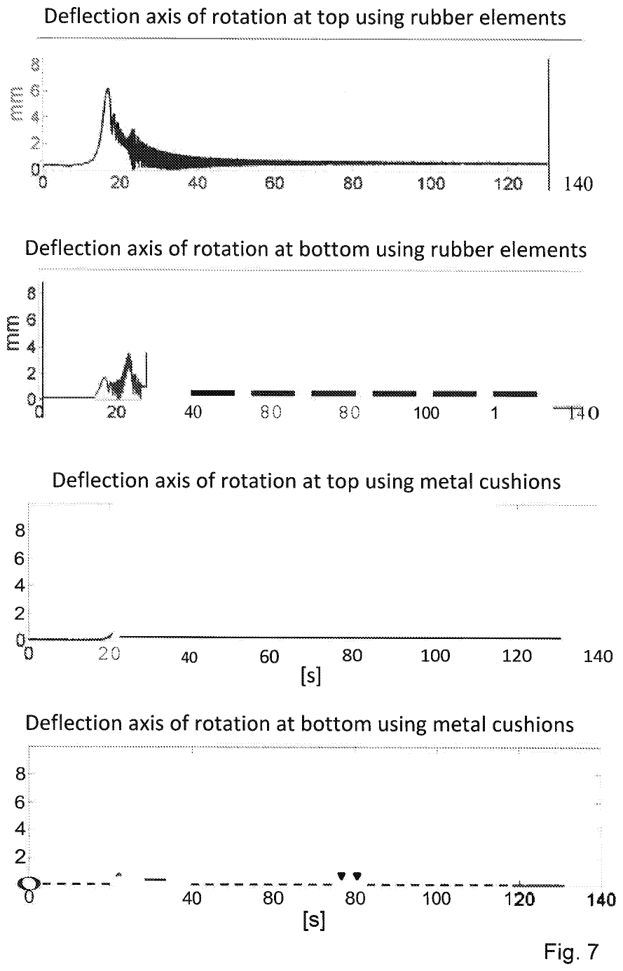

FIG. 7 shows diagrams illustrating the deflection of the axis of rotation with natural rubber elements and with metal cushions.

FIGS. 1 to 5 are different views of five different embodiments of a laboratory centrifuge 10, with FIG. 1 showing the prior art, and FIGS. 2 to 5 showing four different embodiments according to the invention. For better visibility of the essential elements of the invention, not all the components of the laboratory centrifuge 10 are shown in the drawings. Only those components of the individual embodiments that are necessary for understanding the invention are shown in the respective Figures.

FIGS. 1a to 1f show a first embodiment of a prior art laboratory centrifuge 10.

In an interior 14 of a centrifuge housing 12, a motor 18 is arranged on a base plate 16 via three supports 20, 22, and 24. The base plate 16 has four integral feet 26 on the underside of the base plate 16, which feet 26 are provided in the corner regions of the base plate 16. Via its feet 26, the laboratory centrifuge 10 stands on a lab bench, for example.

The centrifuge housing 12 closes off the interior 14 at the top and has a recess 30 concentric with a motor axis 28, through which a rotor 32 can be loaded.

A centrifuge lid 34 engages in the recess 30 in certain areas, thereby closing off the interior 14. Ambient air flows into the interior 14 via a concentrically arranged ventilation opening 36 and another laterally arranged ventilation opening 38 during operation of the laboratory centrifuge 10. For this purpose, the centrifuge lid 34 has a double-shell design, which creates a flow channel 34a between the lateral ventilation opening 38 and the concentric ventilation opening 36. The centrifuge lid 34 is pivotably mounted on the centrifuge housing 12 in a conventional manner.

Adjacent to the concentric recess 30 of the centrifuge housing 12 is a safety vessel 40, which is firmly connected to the centrifuge housing 12. A drive shaft 42 engages through the safety vessel 40 through a corresponding bore made in the bottom of the safety vessel. The rotor 32 is arranged in a rotationally fixed manner on the drive shaft 42 connected to the motor 18. The rotor 32 is driven in a known manner by the motor 18 via the drive shaft 42.

The motor 18 is firmly mounted and arranged in a bearing unit 44. The bearing unit 44 is connected to the base plate 16 via the supports 20, 22, 24. For this purpose, the bearing unit 44 has a plate-shaped projection 44a, 44b, 44c each. More specifically, plate-shaped projection 44a is associated with support 20, plate-shaped projection 44b is associated with support 22, and plate-shaped projection 44c is associated with support 24. The supports 20, 22, 24 act to position the bearing unit 44 at a predetermined distance from the base plate 16.

The support 20 has a damping element in the form of a rubber cushion 20a, which rests against the base plate 16. The rubber cushion 20a is formed as a cylinder. A threaded bolt 20b is attached to each end face of the rubber cushion 20a and is fastened to the base plate 16. The underside of the plate-shaped projection 44a rests against the upper side of the rubber cushion 20a. A nut 20c, which is screwed onto the bolt 20b and presses against the upper side of the plate-shaped projection 44a, retains the bearing unit 44 in place on the rubber cushion 20a of the support 20. A washer 20d is interposed between the nut 20c and the top of the plate-shaped projection 44a.

Supports 22 and 24 are of the same structure.

Support 22 has a damping element in the form of a rubber cushion 22a which rests against the base plate 16. The rubber cushion 22a is formed as a cylinder. A threaded bolt 22b is attached to the end faces of the rubber cushion 22a and is fastened to the base plate 16. The underside of the plate-shaped projection 44b rests against the upper side of the rubber cushion 22a. A nut 22c, which is screwed onto the bolt 22b and presses against the upper side of the plate-shaped projection 44b, retains the bearing unit 44 in place on the rubber cushion 22a of the support 22. A washer 22d is interposed between the nut 22c and the top of the plate-shaped projection 44b.

Support 24 has a damping element in the form of a rubber cushion 24a which rests against the base plate 16. The rubber cushion 24a is formed as a cylinder. A threaded bolt 24b is attached to the end faces of the rubber cushion 24a and is fastened to the base plate 16. The underside of the plate-shaped projection 44c rests against the upper side of the rubber cushion 24a. A nut 24c, which is screwed onto the bolt 24b and presses against the upper side of the plate-shaped projection 44c, retains the bearing unit 44 in place on the rubber cushion 24a of the support 24. A washer is interposed between the nut 24c and the top of the plate-shaped projection 44b.

The rubber cushions 20a, 22a, 24a each have a spring axis 20e, 22e, 24e that is identical to the axis of the associated screw 20b, 22b, 24b and is aligned in parallel to the motor axis 28.

The motor 18, with the drive shaft 42 and the rotor 32, is thus completely disposed within the bearing unit 44 and is supported by the latter. These parts are connected to the centrifuge housing 12 via the supports 20, 22, 24. The rubber cushions 20a, 22a, 24a support the bearing unit 44 in the centrifuge housing and prevent noise generation. Damping properties, however, are insufficient.

Illustrated in FIGS. 2a to 2f is a first embodiment of a laboratory centrifuge 10 according to the invention. In the following, the same reference signs will be used to denote the same parts. Moreover, only the differences with respect to the prior art embodiment will be addressed.

With reference to the embodiment of FIG. 1, different supports 46, 48, 50 are provided in this case. The plate-like projections 44a, 44b, 44c rest against a first metal cushion 46a, 48a, 50a each. These first metal cushions 46a, 48a, 50a are preloaded by the weight of the mass of the motor 18 and rotor 32. Moreover, the first metal cushions 46a, 48a, 50a are slightly shorter than the rubber cushions 20a, 22a, 24a of FIG. 1 and rest on a bearing shoulder 46f, 48f, 50f. The bearing shoulder 46f, 48f, 50f is respectively bolted to the base plate 16. From the bearing shoulder 46f, 48f, 50f, the bolt 46b, 48b, 50b extends upward, passes through the plate-shaped projection 44a, 44b, 44c, a second metal cushion 46g, 48g, 50g that is of identical design as the first metal cushion 46a, 48a, 50a, and the washer 46d, 48d, 50d. The nut 46c, 48c, 50c is screwed onto the bolt 46b, 48b, 50b and presses on the washer and the second metal cushion 46g, 48g, 50g. Furthermore, a second washer 46h, 48h, 50h is interposed between the second metal cushion 46g, 48g, 50g and the bearing shoulder 46f, 48f, 50f.

In this way, the first metal cushion 46a, 48a, 50a thus counteracts a downward movement and the second metal cushion 46g, 48g, 50g counteracts an upward movement. They are each only subjected to compressive loads, thus allowing the optimum damping properties of the metal cushions to take effect.

Illustrated in FIGS. 3a to 3f is a second embodiment of a laboratory centrifuge 10 according to the invention. In the following, the same reference signs will be used to denote the same parts. Moreover, only the differences with respect to the centrifuge of FIG. 1 and the first embodiment will be addressed here.

This embodiment has a total of six supports, namely three supports 20, 22, 24 according to FIG. 1 and three supports 46, 48, 50 according to the first embodiment of the invention. As a result, the bearing unit 44 has six plate-like projections 44d, 44e, 44f, 44g, 44h, 44i. More specifically, projection 44d is associated with support 20, projection 44e is associated with support 22, projection 44f is associated with support 24, projection 44g is associated with support 46, projection 44h is associated with support 48 and projection 44i is associated with support 50. The supports 20, 22, 24, 46, 48, 50 mounted on the base plate 16 equally spaced from one another and concentrically to the motor axis 28. More specifically, in a counterclockwise sense, support 46 is arranged next to support 20, support 22 is arranged next to support 46, support 48 is arranged next to support 22, support 24 is arranged next to support 48, support 50 is arranged next to support 24, and support 20 is arranged next to support 50. As a result, the type of supports 20, 22, 24 of FIG. 1 are alternatingly arranged with the type of supports 46, 48, 50 of the first embodiment of the invention. This has the advantage that the required damping of the bearing unit 44 of the centrifuge 10 is achieved essentially through the supports 46, 48, 50, and the bearings 20, 22, 24 thereby absorb the load of the motor with the rotor, so that the lower and upper metal cushions are subjected to equal loads. This allows the use of metal cushions that are optimized for damping. The load of the motor with the rotor need not be considered in the design of the metal cushions.

Illustrated in FIGS. 4a to 4f is a third embodiment of a laboratory centrifuge 10 according to the invention. In the following, the same reference signs will be used to denote the same parts. Moreover, only the differences with respect to the first or second embodiment according to the invention and the centrifuge 10 of FIG. 1 will be addressed here.

This embodiment, same as the second embodiment, has a total of six supports, namely three supports 20, 22, 24 according to FIG. 1 and three supports 52, 54, 56 with horizontal damping. The bearing unit 44 has three plate-shaped projections 44d, 44f, 44h for the supports 20, 22, 24. More specifically, plate-shaped projection 44d is associated with support 20, plate-shaped projection 44f is associated with support 22, and plate-shaped projection 44h is associated with support 24.

Between these three projections 44d, 44f, 44h of the bearing unit 44, bearing brackets 44j, 44k, 44l are provided. A bearing bracket 44j, 44k, 44l initially extends horizontally away from the bearing unit 44 and then vertically upward in parallel to the motor axis 28. At a radial distance relative to the motor axis 28, a support plate 58, 60, 62 extending upward from the base plate 16 in parallel to the motor axis 28 is provided for each of the bearing brackets 44j, 44k, 44l.

Starting from the support plate 58, 60, 62, a second washer 52h, 54h, 56h, a second hollow cylindrical metal cushion 52g, 54g, 56g, the bearing bracket 44j, 44k, 44l, a first metal cushion 52a, 54a, 56a, a first washer 52d, 54d, 56d, a nut 52c, 54c, 56c are arranged in the support 52, 54, 56. A bolt 52b, 54b, 56b is fastened to the support plate 58, 60, 62 and extends through the second washer 52h, 54h, 56h, the second hollow cylindrical metal cushion 52g, 54g, 56g, the bearing bracket 44j, 44k, 44l, the first metal cushion 52a, 54a, 56a, and the first washer 52d, 54d, 56d. The nut 52c, 54c, 56c is threaded onto the bolt 52b, 54b, 56b and presses against the first washer 52d, 54d, 56d and the first metal cushion 52a, 54a, 56a.

The supports 20, 22, 24, 52, 54, 56 are arranged at equal distances from one another on the base plate 16 concentrically to the motor axis 28, wherein, in a counterclockwise sense, support 52 is next to support 20, support 22 is next to support 52, support 54 is next to support 22, support 24 is next to support 54, support 56 is next to support 24, and support 20 is next to support 56. Thus, the first type of supports 20, 22, 24 of the first embodiment are alternatingly arranged with the third type of supports 52, 54, 56.

The supports 52, 54, 56 have spring axes 52e, 54e, 56e. The spring axes 52e, 54e, 56e of the supports 52, 54, 56 are aligned perpendicular to the motor axis 28. The supports therefore counteract possible deflections of the motor 18 and the rotor 32.

Also in this embodiment, damping is essentially achieved by the supports 52, 54 and 56. The metal cushions are again only subjected to compressive loads, so that the metal cushions can develop their optimum damping properties. The rubber cushions 20a, 22a, 24a absorb the load of the motor with the rotor. This allows the use of metal cushions that are optimized for damping.

Illustrated in FIGS. 5a to 5f is a fourth embodiment of a laboratory centrifuge 10 according to the invention. In the following, the same reference signs will be used to denote the same parts. Moreover, only the differences with respect to the first, second or third embodiments according to the invention will be addressed here.

The bearing unit 44 is formed in the same manner as the first embodiment. However, a different design of support has been used in this case. Three supports 64, 66, 68 are provided which are associated with the plate-shaped projections 44a, 44b, 44c, respectively. Radially spaced from the plate-shaped projection 44a, 44b, 44c is a mounting bracket 70, 72, 74. Each mounting bracket 70, 72, 74 extends vertically upward from the base plate 16 and is then angled horizontally toward the motor axis 28. The bearing unit 44 is supported via the mounting brackets 70, 72, 74. Starting from the support plate 58, 60, 62, a second washer 64h, 66h, 68h, a second metal cushion 64g, 66g, 68g, the bearing bracket 70 72, 74, a first metal cushion 64a, 66a, 68a, a first washer 64d, 66d, 68d and a nut 64c, 66c, 68c are provided.

A bolt 64b, 66b, 68b is fastened to the plate-shaped projection 44a, 44b, 44c, and extends through the second washer 64h, 66h, 68h, the second hollow cylindrical metal cushion 64g, 66g, 68g, the mounting bracket 70, 72, 74, the first metal cushion 64a, 66a, 68a, and the first washer 64d, 66d, 68d. The nut 64c, 66c, 68c is threaded onto the bolt 64b, 66b, 68b and presses against the first washer 64d, 66d, 68d and the first metal cushion 64a, 66a, 68a.

The supports 64, 66, 68 are each provided with a spring axis 64e, 66e, 68e, which is aligned in parallel to the motor axis 28. However, the bearing unit does not rest on the supports 20, 24, 26 according to the first embodiment, but is supported by the supports 64, 66, 68 via the mounting bracket 70, 72, 74. In this case, the first retaining cushion 64a, 66a, 68a is located above the mounting bracket 70, 72, 74, and the second retaining cushion 64g, 66g, 68g is arranged between the plate-shaped projection 44a, 44b, 44c of the bearing unit 44 and the mounting bracket 70, 72, 74.

In this embodiment, the bearing unit 44 is suspended and is damped by the metal cushions 64a, 66a, 68a in one direction and the metal cushions 64g, 66g, 68g in the other direction.

The metal cushions used in the described embodiments of the invention are cylindrical in shape and have an outer diameter ranging from 12 mm up to and including 50 mm. The inner diameter is in a range of between 4 mm and 12 mm. The washers completely cover the face of the metal cushion. The bolt passes through the metal cushion in such a way that the cushion remains free to move relative to the bolt.

The various embodiments can be used to optimize various applications of the centrifuge 10. The metal cushions cause a maximum deflection at the level of the rotor of less than 2 mm, in particular less than 1.5 mm. At the level of the metal cushions, the maximum deflection is less than 1 mm, preferably less than 0.9 mm.

The metal cushion may be formed by a steel wire that contains chromium-nickel, which makes it a stainless steel wire. The diameter of the steel wire is in a range from 0.05 mm up to and including 0.5 mm.

The damping coefficient k of the metal cushions used in each embodiment is in the following ranges for a given excitation frequency:
for an excitation frequency of 1 Hz, the damping coefficient k is between 500 and 8,000 Ns/m;
for an excitation frequency of 10 Hz, the damping coefficient k is between 300 and 5,000 Ns/m;
for an excitation frequency of 20 Hz, the damping coefficient k is between 200 and 2,500 Ns/m;
for an excitation frequency of 50 Hz, the damping coefficient k is between 80 and 1,200 Ns/m;
for an excitation frequency of 100 Hz, the damping coefficient k is between 40 and 500 Ns/m;

The use of the metal cushions described above instead of, or in addition to, the rubber elements commonly used to date creates a high degree of imbalance tolerance in a small installation space.

This becomes apparent from the following comparison between a metal cushion of the type described above and a conventionally used rubber element:

In the rubber elements used, the damping coefficient decreases, starting from a very low value, as the excitation frequency increases. From a frequency of approx. 30 Hz, there is practically no damping left, see FIG. 6, i.e. diagrams depicting the deflection of the motor shaft at the top (in the area of the rotor) and at the bottom (in the area of the bearing, i.e. the damping elements).

The frequency spectrum is traversed as a function of time. The rotor is accelerated from standstill to rated speed, see FIG. 7.

As can be seen from FIG. 7, use of the metal cushions according to the invention allows deflection to be reduced from approx. 6 mm to approx. 1 mm. Conversely, in the same centrifuge, with unchanged dimensions (distance from rotor to centrifuge vessel), the permissible imbalance can be significantly increased.

### LIST OF REFERENCE SIGNS

10 laboratory centrifuge

12 centrifuge housing

14 interior of centrifuge housing 12

16 base plate

18 motor

20 support—left—first type

20a metal cushion

20b bolt

20c nut

20d washer

20e spring axis

22 support—front—first type

22a metal cushion

22b bolt

22c nut

22d washer

22e spring axis

24 support—right—first type

24a metal cushion

24b bolt

24c nut

24d washer

24e spring axis

26 foot of base plate 16

28 motor axis/rotor axis

30 recess in centrifuge housing 12

32 rotor

34 centrifuge lid

34a flow channel

36 ventilation opening—concentric

38 ventilation opening—lateral

40 safety vessel

42 drive shaft

44 bearing unit for motor 18

44a plate-shaped projection—associated with support 20 and 46 respectively

44b plate-shaped projection—associated with support 22 and 48 respectively

44c plate-shaped projection—associated with support 24 and 50 respectively

44d plate-shaped projection—associated with support 20

44e plate-shaped projection—associated with support 46

44f plate-shaped projection—associated with support 22

44g plate-shaped projection—associated with support 48

44h plate-shaped projection—associated with support 24

44i plate-shaped projection—associated with support 50

44j bearing bracket—associated with support 52

44k bearing bracket—associated with support 54

44l bearing bracket—associated with support 56

46 support—left—second type

46a first metal cushion

46b bolt

46c nut

46d first washer

46e spring axis

46f bearing shoulder

46g second metal cushion

46h second washer

48 support—center—second type

48a first metal cushion

48b bolt

48c nut

48d first washer

48e spring axis

48f bearing shoulder

48g second metal cushion

48h second washer

50 support—right—second type

50a first metal cushion

50b bolt

50c nut

50d first washer

50e spring axis

50f bearing shoulder

50g second metal cushion

50h second washer

52 support—left—third type

52a first metal cushion

52b bolt

52c nut

52d first washer

52e spring axis

52g second metal cushion

52h second washer

54 support—center—third type

54a first metal cushion

54b bolt

54c nut

54d first washer

54e spring axis

54g second metal cushion

54h second washer

56 support—right—third type

56a first metal cushion

56b bolt

56c nut

56d first washer

56e spring axis

56g second metal cushion

56h second washer

58 support plate of support 52

60 support plate of support 54

62 support plate of support 56

64 support

64a first metal cushion

64b bolt

64c nut

64d first washer

64e spring axis

64g second metal cushion

64h second washer

66 support

66a first metal cushion

66b bolt

66c nut

66d first washer

66e spring axis

66g second metal cushion

66h second washer

68 support

68a first metal cushion

68b bolt

68c nut

68d first washer

68e spring axis

68g second metal cushion

68h second washer

70 mounting bracket

72 mounting bracket

74 mounting bracket

1-23. (canceled)

24. Centrifuge (10), in particular a laboratory centrifuge, comprising:
a) a rotor (32) for receiving containers with material to be centrifuged,
b) a drive shaft (42) on which the rotor (32) is mounted,
c) a motor (18) which drives the rotor (32) via the drive shaft (42),
d) a bearing unit (44) having bearings (46, 48, 50, 52, 54, 56; 64, 66, 68) which each have damping elements (46a, 48a, 50a; 52a, 54a, 56a, 64a, 66a, 68a) comprising a spring axis (46e, 48e, 50e; 52e, 54e, 56e; 64e, 66e, 68e),
e) a carrier element (16) for fixing the motor (18) via the bearing unit (44) in the centrifuge (10), and,
at least one damping element is formed completely from metal and as a metal cushion (46a, 48a, 50a; 52a, 54a, 56a, 64a, 66a, 68a) comprising a wire knit having elastic properties.

25. Centrifuge according to claim 24, characterized in that the metal cushion (46a, 48a, 50a; 52a, 54a, 56a, 64a, 66a, 68a) is cylindrical in shape.

26. Centrifuge according to claim 24, characterized in that two metal cushions (46a, 48a, 50a; 46g, 48g, 50g; 52a, 54a, 56a; 52g, 54g, 56g; 64a, 66a, 68a; 64g, 66g, 68g) together form a damping element, wherein the first metal cushion (46a, 48a, 50a, 52a, 54a, 56a; 64a, 66a, 68a) counteracts a deflection of the rotor (32) in a first direction and the second metal cushion (46g, 48g, 50g; 52g, 54g, 56g; 64g, 66g, 68g) counteracts a deflection of the rotor (32) in a second, in particular opposite, direction.

27. Centrifuge according to claim 26, characterized in that the bearing unit (44) comprises at least one bearing (46, 48, 50) with a bearing plate (44a, 44b, 44c; 44d, 44e, 44f; 44g, 44h, 44i; 44j, 44k, 44l), wherein on one side of the bearing plate (44a, 44b, 44c; 44d, 44e, 44f; 44g, 44h, 44i; 44j, 44k, 44l) the first metal cushion (46a, 48a, 50a; 52a, 54a, 56a; 64a, 66a, 68a) is arranged and on the second side of the bearing plate (44a, 44b, 44c) the second metal cushion (46g, 48g, 50g; 52g, 54g, 56g; 64g, 66g, 68g) is arranged.

28. Centrifuge of claim 27, characterized in that a guide pin (46b, 48b, 50b; 52b, 54b, 56b; 64b, 66b, 68b) extends through the first metal cushion (46a, 48a, 50a; 52a, 54a, 56a; 64a, 66a, 68a) which rests directly or indirectly against the bearing plate (44a, 44b, 44c; 44d, 44e, 44f; 44g, 44h, 44i; 44j, 44k, 44l), the bearing plate (44a, 44b, 44c; 44d, 44e, 44f; 44g, 44h, 44i; 44j, 44k, 44l) and the second metal cushion (46g, 48g, 50g; 52g, 54g, 56g; 64g, 66g, 68g) which rests directly or indirectly against the bearing plate (44a, 44b, 44c; 44d, 44e, 44f; 44g, 44h, 44i; 44j, 44k, 44l) and the carrier element (16), wherein the guide pin (46b, 48b, 50b; 52b, 54b, 56b; 64b, 66b, 68b) is fixedly connected to the carrier element (16) on one side and has a head on the other side which bears indirectly or directly against the first metal cushion (46a, 48a, 50a; 52a, 54a, 56a; 64a, 66a, 68a), wherein the first metal cushion (46a, 48a, 50a; 52a, 54a, 56a; 64a, 66a, 68a), the bearing plate (44a, 44b, 44c) and the second metal cushion (46g, 48g, 50g; 52g, 54g, 56g; 64g, 66g, 68g) are freely movable relative to the guide pin (46b, 48b, 50b; 52b, 54b, 56b; 64b, 66b, 68b).

29. Centrifuge according to claim 24, characterized in that the damping elements (20a, 22a, 24a; 46a, 48a, 50a; 52a, 54a, 56a; 64a, 66a, 68a) of different bearings (20, 22, 24; 46, 48, 50; 52, 54, 56; 64, 66, 68) are designed differently, in particular the damping elements (46a, 48a, 50a; 52a, 54a, 56a; 64a, 66a, 68a) of a first bearing (46, 48, 50; 52, 54, 56; 64, 66, 68) are optimized with respect to damping, and the damping elements (20, 22, 24) of a second bearing (20, 22, 24) are optimized with respect to absorbing the weight force.

30. Centrifuge according to claim 29, characterized in that one damping element comprises at least one metal cushion (46a, 48a, 50a; 52a, 54a, 56a; 64, 66, 68) and the other damping element (20a, 20b, 20c) comprises at least natural rubber.

31. Centrifuge according to claim 24, characterized in that adjacent damping elements (20a, 20b, 20c; 46a, 48a, 50a; 52a, 54a, 56a; 64, 66, 68) are equally spaced from one another in the circumferential direction relative to the drive axis (42).

32. Centrifuge according to claim 24, characterized in that at least one spring axis (52e, 54e, 56e) of a damping element is aligned perpendicular to the drive shaft (42).

33. Centrifuge according to claim 24, characterized in that at least one spring axis (20e, 20e, 20e; 46e, 48e, 50e; 64e, 66e, 68e) of a damping element (20a, 22a, 24a; 46a, 48a, 50a; 64a, 66a, 68a) is aligned in parallel to the drive shaft (42).

34. Centrifuge according to claim 32, characterized in that multiple bearings (20, 22, 24; 52, 54, 56) with damping elements (20a, 22a, 24a; 52a, 54a, 56a) are provided, wherein the spring axes (52e, 54e, 56e) of half of the damping elements (52a, 54a, 56a) are aligned perpendicular to the drive shaft (42), and the spring axes (20e, 22e, 24e) of the other half of the damping elements (20a, 22a, 24a) are aligned in parallel to the drive shaft (42).

35. Centrifuge according to claim 32, characterized in that alternatingly the spring axes (52e, 54e, 56e) of the damping elements (52a, 54a, 56a) are aligned perpendicular to the drive shaft (42) and the spring axes (20e, 22e, 24e) of the damping elements (20a, 22a, 24a) are aligned in parallel to the drive shaft (42).

36. Centrifuge according to claim 24, characterized in that the damping elements (46a, 48a, 50a; 52a, 54a, 56a; 62, 64, 66) permit a maximum deflection in the region of the rotor (32) of less than 2 mm, in particular of less than 1.5 mm.

37. Centrifuge according to claim 24, characterized in that the damping elements (46a, 48a, 50a; 52a, 54a, 56a, 64a, 66a, 68a) permit a maximum deflection in the region of the damping element (20a, 22a, 24a) of less than 1 mm, in particular of less than 0.9 mm.

38. Centrifuge according to claim 24, characterized in that three damping elements (20a, 22a, 24a; 46a, 48a, 50a; 52a, 54a, 56a, 64a, 66a, 68a) are provided, the spring axis (20e, 22e, 24e; 46e, 48e, 50e; 52e, 54e, 56e; 64e, 66e, 68e) of each of which is aligned identically.

39. Centrifuge according to claim 24, characterized in that a washer (20d, 22d, 24d; 46d, 48d, 50d; 52d, 54d, 56d, 64d, 66d, 68d), in particular a metal washer, delimits the damping element (20a, 22a, 24a; 46a, 48a, 50a; 52a, 54a, 56a, 64a, 66a, 68a) in the direction of the spring axis (20e, 22e, 24e; 46e. 48e, 50e; 52e, 54e, 56e, 64e, 66e, 68e) on one side.

40. Centrifuge according to claim 39, characterized in that the washer (20d, 22d, 24d; 46d, 48d, 50d; 52d, 54d, 56d, 64d, 66d, 68d) covers the entire damping element (20a, 22a, 24a; 46a, 48a, 50a; 52a, 54a, 56a, 64a, 66a, 68a) in the direction of the spring axis (20e, 22e, 24e; 46e, 48e, 50e; 52e, 54e, 56e, 64e, 66e, 68e).

41. Centrifuge according to claim 24, characterized in that the metal cushion (46a, 48a, 50a; 52a, 54a, 56a, 64a, 66a, 68a) is formed by a steel wire that contains chromium-nickel.

42. Centrifuge according to claim 41, characterized in that the steel wire is from 0.05 mm up to and including 0.5 mm in diameter.

43. Centrifuge according to claim 24, characterized in that the outer diameter of the metal cushion (46a, 48a, 50a; 52a, 54a, 56a, 64a, 66a, 68a) is from 12 mm up to and including 50 mm.

44. Centrifuge according to claim 24, characterized in that the metal cushion (46a, 48a, 50a; 52a, 54a, 56a, 64a, 66a, 68a) is designed as a hollow cylinder, in particular with an inner diameter of between 4 mm and 12 mm.

45. Centrifuge according to claim 24, characterized in that the damping coefficient k of the metal cushion (46a, 48a, 50a; 52a, 54a, 56a, 64a, 66a, 68a) is
between 500 and 8,000 Ns/m for an excitation frequency of 1 Hz;
between 300 and 5,000 Ns/m for an excitation frequency of 10 Hz;
between 200 and 2,500 Ns/m for an excitation frequency of 20 Hz;
between 80 and 1,200 Ns/m for an excitation frequency of 50 Hz;
between 40 and 500 Ns/m for an excitation frequency of 100 Hz.

46. Centrifuge according to claim 24, characterized in that the stiffness (c) of the metal cushion (46a, 48a, 50a; 52a, 54a, 56a, 64a, 66a, 68a) is in a range of between 3 N/mm and 300 N/mm.
